(19) United States
(12) Patent Application Publication
(10) Pub. No.: US 2023/0407001 A1
(43) Pub. Date: Dec. 21, 2023

(54) PROCESS FOR PREPARING A MIXTURE OF RECYCLED TEREPHTHALIC ACID AND ISOPHTHALIC ACID

(71) Applicant: RITTEC UMWELTTECHNIK GMBH, Lüneburg (DE)

(72) Inventors: Lars BIERMANN, Braunschweig (DE); Esther BREPOHL, Braunschweig (DE); Carsten EICHERT, Reppenstedt-Dachtmissen (DE); Clemens MÜLLER, Braunschweig (DE); Vitalij SALIKOV, Seevetal (DE); Stephan SCHOLL, Braunschweig (DE)

(21) Appl. No.: 18/251,653

(22) PCT Filed: May 25, 2021
(86) PCT No.: PCT/EP2021/063917

§ 371 Date: May 3, 2023

(30) Foreign Application Priority Data
Sep. 11, 2020 (DE) 10 2020 123 772.3

(51) Int. Cl. C08G 63/183; C08J 11/16; C08G 63/78; C08J 11/18

(52) U.S. Cl. CPC C08G 63/183; C08J 11/16; C08G 63/78; C08J 11/18; C08J 2367/02

(57) ABSTRACT

The invention relates to a method for producing a mixture of recycled terephthalic acid (r-TA) and recycled iso-terephthalic acid (r-IA) from condensation polymer waste (CP waste) to obtain a mixture of r-TA and r-IA having set r-IA isomer content between 0.001% by weight and 25% by weight of the mixture, for which waste having different IA contents is mixed and processed.

The present invention relates to a method for producing a mixture of recycled terephthalic acid (r-TA) and recycled isophthalic acid (r-IA), the mixing ratio of which can be set according to the invention in a targeted manner, and a corresponding mixture.

Polyethylene terephthalate plastics (PET) are used on a large scale, among other things as beverage bottles, food packaging such as salad bowls, sausage and cheese packaging, fibers, textiles, automotive components, clear, opaque or colored detergent bottles and production waste. Condensation polymers are generally used for these purposes, particularly polyethylene naphthalate, poly(ethylene terephthalate-co-isophthalate) copolymer, polypropylene terephthalate, polybutylene terephthalate, polyethylene terephthalate copolymer with 1,4-cyclohexanedicarboxylate structural units.

They are produced directly from basic chemicals of fossil origin as so-called virgin PET and/or obtained from recycled plastics that come completely or partially from a mechanical material recycling process and are referred to as r-PET. These recycling processes are often time-consuming if the plastics to be recycled are multilayer composite materials based on polymers. In addition to PET, they often also have a thin layer of polyethylene (PE) or polyamide (PA) or ethylene vinyl alcohol copolymer (EVOH) as a barrier layer, or one made of ethylene vinyl acetate copolymer (EVA) as a water-repellent layer. The following layers can be present individually or in combination: cardboard, polyvinyl alcohol (PVOH), polypropylene (PP), polystyrene (PS) or their copolymers and metals. Recycling is not easy even when plastic waste is almost completely sorted. A number of processes are known from the prior art for obtaining terephthalic acid from PET waste, the terephthalic acid being able to be reused as a raw material and being referred to as r-TA. These processes operate either with high pressures and/or with high temperatures and often also in batch processes and are therefore rather uneconomical. It is known PET-containing waste is decomposed in a continuous process by means of a base-catalyzed depolymerization using NaOH and adding an alcohol.

When producing PET and other condensation polymers according to the prior art, purified isophthalic acid (PIA) is added to the polymerization mixture in addition to purified terephthalic acid (PTA), in order to influence the properties of the future polymer. The molar ratio is usually 99:1 (mol PTA to mol PIA). PTA and PIA are also used for the production of saturated and unsaturated polyester resins and alkyd resins. These are used, among other things, as solid material or as part of a composite material for the production of structural components and for the production of coatings, sealants, adhesives, paints and varnishes.

It is the object of the invention to provide a method for producing improved r-TA and r-TA itself.

The procedural task is achieved with a method comprising the steps:
analyzing PET waste with regard to its IA content,
dividing the PET waste into two or more fractions having different IA content,
mixing the fractions to achieve a desired IA content in the mixture,
processing the mixture to obtain a mixture of r-TA and r-IA having adjusted r-IA isomer content between 0.001% by weight and 25% by weight of the mixture.

With great advantage, the invention opens up the possibility of recycling plastic material from different sources, thereby setting a ratio of r-TA/r-IA that is very advantageous for later use. The plastics to be recycled are processed in a continuous reactor and the corresponding dicarboxylic acids and diols are obtained as products, that is, in the case of PET, a benzene dicarboxylic acid in the form of the isomers r-TA and r-IA and monoethylene glycol (MEG). The ratio generated according to the invention is very advantageously such that there is a reduced procedural effort for the production of r-PET using r-TA, since it already contains a proportion of r-IA, whereby subsequent admixing and thus a work step can be omitted.

In the method step of analyzing according to the invention, samples taken from the recycling material are processed and, particularly, analyzed by means of HPLC. The recycling material is then divided into, particularly, two fractions, a first fraction having an IA proportion of <0.1% by weight and a second fraction having an IA proportion of >0.1% by weight, preferably >1% by weight, particularly preferably >1.5% by weight. There is preferably a division into three fractions, wherein the third fraction has an IA proportion of >3% by weight. If the recycling material should be sorted, it usually has a single, roughly constant IA content. Different recycling materials sorted to a high purity such as bottles, thermoformed packaging, polyester textiles, production waste and the like therefore also have different IA contents, particularly different IA contents that are typical for the respective recycling material. They can therefore be used as the fraction according to the invention. It is also according to the invention to create a fraction having an IA content required for the later step of mixing from recycling materials that have different IA contents. This also includes the reduction of an IA content of a first recycling material by admixing a low-IA, second recycling material in the desired ratio, and increasing the IA content of the first by admixing a second material having a higher content, also in the desired ratio. An IA content tailored to the later application can advantageously be obtained in this way.

According to the invention, a step of compacting one or more fractions is optionally provided before the mixing step takes place. This can be necessary or desirable particularly with fibrous starting materials in order to improve later processability.

In the step of mixing the fractions, they are mixed with one another in accordance with the mixing specification from the “analysis” method step, particularly via gravimetric metering by means of a solids dispenser in a suitable mixing device such as a drum mixer. Alternatively and particularly advantageously, the waste is mixed directly when the waste is metered into an extruder with the aid of a corresponding number of gravimetric metering units. According to the invention, the mixture is adjusted so that the isomer ratio (mol TA to mol IA) determined from the analysis step is between 100:0 and 75:25, preferably between 99:1 and 90:10 and optimally between 99:1 and 97:3.

After mixing, the PET waste mixture is processed to obtain a mixture of r-TA and r-IA having an adjusted r-IA isomer content of between 0.001% by weight and 25% by weight of the resulting mixture of r-TA and r-IA. The processing comprises particularly the steps of base-catalyzed depolymerization, in which a diol is formed which can be obtained, and the steps of separation and purification of r-TA and r-IA.

The obtained r-TA/r-IA mixture typically has the same or a very similar isomer ratio as the starting polymer or as the fraction mixture before the processing step, which is often 99:1 (mol r-TA:mol r-IA). As a result, the isomer mixture obtained can, according to the invention, be fed to a step of polycondensation to PET without or with only a small addition of isophthalic acid or terephthalic acid. This is a cost advantage as IA has a higher market price than TA. By using the mixture according to the invention, the laborious separation of the isomers during the recycling and the readjustment of the isomer mixture before the r-PET polymerization are dispensed with to great advantage.

In an alternative embodiment of the method, the r-TA/r-IA mixture obtained after the processing step is separated into its isomers using methods known from the literature, such as recrystallization or melt crystallization, in order to obtain the more interesting r-IA.

The material object is achieved by a mixture of r-TA and r-IA having an adjusted r-IA isomer content of between 1.5% by weight and 3% by weight of the mixture of r-TA and r-IA, particularly obtainable by a method as described.

The application task is achieved by using the mixture as described in a polymerization reaction to form r-PET.

The method is also described below in the form of an embodiment and in detail using figures.

General Procedure

To determine its isophthalic acid content (IA), the waste sample is prepared for analysis through a pretreatment step such as depolymerization or transesterification, and the analysis is then carried out using chromatography (GC, HPLC) or NMR spectroscopy.

The content information obtained in this way for the individual waste fractions is processed into a mixing specification. This is used to set the desired content of isophthalic acid in the crude product at the end of the processing step.

The waste fractions that are either already present or compiled according to the invention are optionally comminuted and/or compacted in a subsequent method step. This is advantageous for fibers and fiber-like waste fractions and low-strength film materials in order to ensure problem-free feeding into the “depolymerization” method stage.

After the optional compaction, the waste fractions are mixed with one another in the “mixing” method step in accordance with the mixing specification from the “analysis” method step. Mixing takes place via gravimetric metering using a solids dispenser in a suitable mixer, for example, a drum mixer. However, it is preferred to mix the waste directly when it is metered into the extruder using one gravimetric metering unit for each waste fraction. According to the invention, the isomer ratio (mol TA:mol IA) is set between 100:0 and 75:25, preferably between 99:1 and and optimally between 99:1 and 97:3.

The step of processing the condensation polymer waste, such as polyethylene naphthalate, polyethylene terephthalate, poly(ethylene terephthalate-co-isophthalate) copolymer, polybutylene terephthalate and polyethylene terephthalate copolymer with 1,4-cyclohexanedicarboxylate structural unit waste, is the “depolymerization” sub-step in a continuously operating twin-screw extruder into which the proportions of the fractions are gravimetrically metered in accordance with the mixing specification. The saponification or depolymerization reaction of the condensation polymer takes place continuously in the extruder with the addition of solid sodium hydroxide. According to the invention, water is optionally metered in at suitable points. 6.66 kg/h of PET-containing waste, 2.91 kg/h of sodium hydroxide and up to 10 kg/h of water were processed in this embodiment. The ratio of sodium hydroxide to PET waste is set during the process so that a constant stoichiometric ratio of about 2.1 is maintained based on the constitutional repeating unit of polyalkylene terephthalate or the above-mentioned polyethylene isophthalate copolymer, polybutylene terephthalate and polyethylene terephthalate copolymer with 1,4-cyclohexanedicarboxylate structural units.

When the condensation polymer reacts with sodium hydroxide, one mole of dialcohol is released per repeating unit of the polymer, in the case of PET monoethylene glycol (MEG) and traces of diethylene glycol (DEG). This MEG or DEG is recovered during or after the extrusion process by distillation and it is fed to the processing or the plastics cycle after purification by distillation, rectification or adsorption.

This sub-step produces a further reaction product, the salt of a dicarboxylic acid, disodium terephthalate in the case of PET and sodium hydroxide as the starting material. It is soluble in water (at 20° C. approx. 140 g/L solution), so that the addition of water to the extruder starts the dissolving process in the extruder, which shortens the next processing sub-step, which would take significantly longer. The addition of water to the extruder reduces the viscosity and thus improves the conveyability of the material flow, which facilitates a continuous process. A further addition of water after the extrusion is optionally carried out according to the invention, for example, in a stirring tank or by an in-line disperser, which simultaneously transports the dissolved raw product further in the system by means of its pumping action.

The reaction discharge from the extruder consists of an aqueous suspension of disodium terephthalate and isophthalate, MEG, unreacted portions of sodium hydroxide and PET waste, such as PET residues. Depending on the composition of the input material, it may also contain small amounts of breakdown products from PA and dyes and other polymers such as PE, PP and PS.

Polyolefins, such as PE or PP, and polyamides, such as PA 6.6, emerge chemically unchanged from the process under the preferred operating conditions (T=130° C.-160° C.) and can be separated easily and effectively in the subsequent “filtration” processing sub-step. 92% to 97% of the polyalkylene is depolymerized during the single conveyance of the polyalkylene-containing starting material through the extruder. The raw product solution of disodium terephthalate subsequently obtained by adding more water, in the case of PET as input material, is cleaned of impurities and foreign substances by a purification cascade consisting of a plurality of filtration stages and subsequent adsorption and/or extraction.

The mixture of r-TA and r-IA is precipitated from the purified raw product solution by adding an acid under suitable conditions and then obtained by means of continuous filtration. The process water and the corresponding salt can be recovered from the mother liquor using suitable methods such as evaporation and crystallization. If necessary, the purity and morphology of the r-TA/r-IA mixture can be further appropriately adjusted in a subsequent recrystallization. For PET as the starting material, the adjusted isomer mixture obtained consists of 75% by weight to 100% by weight r-TA and 25% by weight to 0% by weight r-IA.

According to the invention, this last step can be followed by a polymerization step in which MEG or r-MEG and the mixture obtained are polymerized in a known manner to give an r-PET.

### EMBODIMENT 1

Production waste from the production of multilayer food trays, consisting of PET having a PE layer, forms fraction 1. A polyester textile forms fraction 2 and post-consumer PET bottles form fraction 3. The three fractions are prepared for the recycling process by washing, drying and comminuting to the industry-typical size of <14 mm, possibly also to a size of <3 mm, if required.

A sample is then taken for each waste fraction. 30 g of each sample taken is mixed in a laboratory kneader (Haake PolyLab Rheomix 600) for 5 min at 140° C. with 13.1 g of sodium hydroxide. The paste obtained is then dissolved in 500 mL of water and the residues are filtered off. The filtrate is diluted 1:25 with water and measured using an HPLC. The following operating parameters were set during the HPLC measurement:

TABLE 1
Operating parameters of the HPLC

| Parameter | | |
|---|---|---|
| Column | Phenomenex Gemini 3u C18 110A, | |
| | reversed phase | |
| Device | Thermo Fisher Ultimate 3000 | |
| Column length | 100 | mm |
| Column diameter | 3 | mm |
| Measurement time | 25 | min |
| Eluent | 0.06% phosphoric | |
| | acid:Acetonitrile = 82:18 | |
| Flow | 0.4 | mL/min |
| Column temperature | 35° | C. |
| Injection volume | 0.1 | μL |
| Detector | UV/Vis | |
| Detection wavelength | 240 | nm |
| Retention time | 3.603 | min |
| terephthalic acid | | |
| Retention time | 4.363 | min |
| isophthalic acid | | |

This determination of the IA contents resulted in an IA content of 1.65% for the first fraction, a content of 0.09% for the second and a content of 3.17% for the third.

The comminuted PET-containing waste was then continuously metered in under an inert gas atmosphere into a co-rotating twin-screw extruder by means of a metering device per fraction having a total flow of 10 kg/h, so that there is an isomer ratio of mol TA to mol IA of 98.5:1.5 in the total stream. 4.37 kg/h of NaOH were metered into the twin-screw extruder using a further metering device. The feed streams make it possible to maintain a constant stoichiometric ratio of about 2.1 mol of PET per mol of NaOH based on the constitutional repeat unit of PET. The housing of the extruder was temperature controlled to temperatures of 80° C. to 180° C. in some regions. In the processing section of the extruder, 10 kg/h of water were further added using a metering device in order to dissolve the disodium terephthalate/disodium isophthalate mixture in the reaction product. A twin-screw extruder having closely intermeshing screw elements ensures thorough mixing of the reaction mixture, particularly when sodium hydroxide in bead form is used. The solids are simultaneously subjected to high mechanical stress. The temperature of the depolymerization is chosen below the decomposition point of the respective plastic and particularly below the boiling point of MEG. 92%-97% of the plastic is depolymerized during the single conveyance through the extruder.

The extruder discharge consisted of a suspension of a saturated solution of the disodium terephthalate/disodium isophthalate mixture, undissolved disodium terephthalate/disodium isophthalate mixture, unreacted PET residues, residues of MEG, DEG, dyes and PE residues. When a sample was taken from the extruder discharge, a degree of saponification of 92%-97% based on the PET content of the PET-containing waste could be determined.

A sufficient amount of water was added to the suspension obtained in a subsequent step to completely dissolve the disodium terephthalate/disodium isophthalate mixture and then to subject it to a multi-stage purification cascade, in which impurities were separated off by filtration as well as by adsorptive and/or extractive purification processes according to the prior art. At this point in the recycling process, the PE residues are separated from the PET/PE multilayer material and the dyes from the textile material.

The purified solution is then treated with an acid in order to precipitate the mixture of r-TA and r-IA. Sulfuric acid at a concentration of 25% (w/w) is particularly suitable as an acid according to the invention.

This mixture was processed into the end product by filtration, resuspension, recrystallization, another filtration, and a plurality of waxing steps and subsequent drying. Any remaining impurities such as dyes or bisphenol A are removed. The method according to the invention advantageously also tolerates impurities such as additives, fillers, colorants, pigments, casings, labels, metals and metal coatings, cardboard and the like. The impurities are removed by filtration and/or other procedural steps.

The step of polymerizing the resulting r-TA/r-IA mixture with the MEG obtained from the method according to the invention, or MEG from other sources, is carried out by mixing the two monomers in a stirred, heatable reactor. r-MEG having a weight fraction of 30.8% by weight and r-DEG having a weight fraction of 0.33% by weight and the catalyst antimony glycolate having approx. 0.025% by weight and tetramethylammonium hydroxide having 0.028% by weight were added to the r-TA/r-IA mixture having a weight fraction of 68.8% by weight of the polymerization mixture. The polymerization took place at a temperature of 230° C.-280° C., particularly at 240° C., with vigorous stirring under an inert gas atmosphere. The polycondensation was forced to the product side of the equilibrium by applying a vacuum and distilling off the released water of reaction. After completion of the reaction, r-PET was obtained from the r-TA/r-IA mixture obtained according to the invention.

The figures described below show:

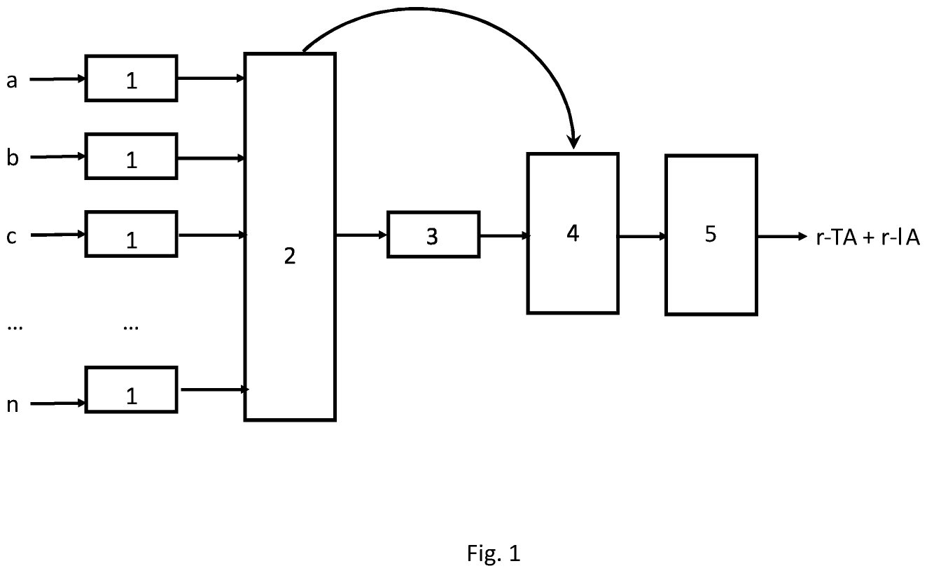

FIG. 1: a diagram of the method according to the invention and

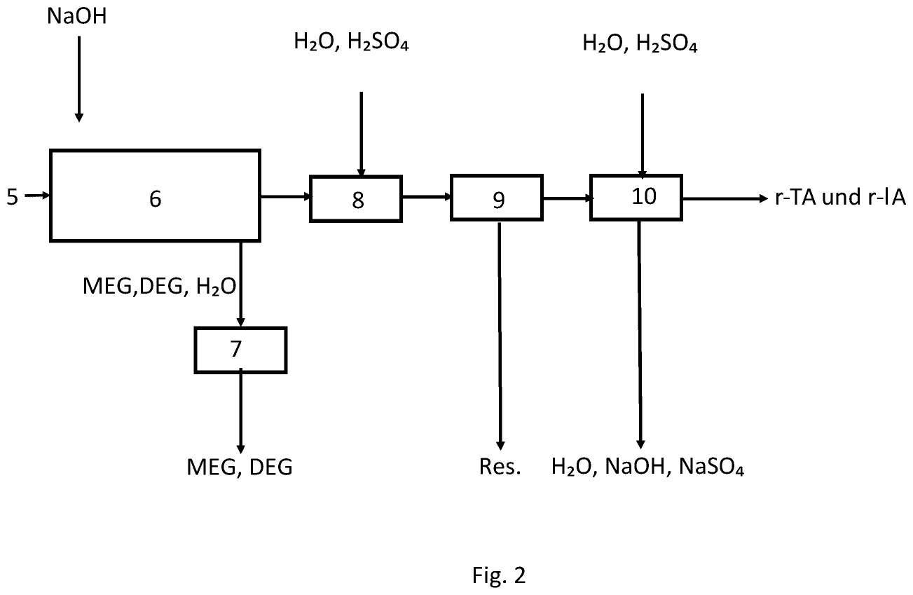

FIG. 2: a diagram of the processing steps of the method according to the invention.

FIG. 1 shows a block diagram of the method according to the invention. The suitable wastes a-n are washed and comminuted in a first step 1, optionally predried, before they are analyzed for their IA content in a second step 2. Based on the results of this analysis, the waste is divided into fractions or classified as such and a mixing specification is created. Optionally, there is a step 3 of compacting, shown here only for waste fraction c, before an obligatory step 4 of mixing the fractions takes place in order to produce a PET waste having a desired IA content. This is illustrated with the curved arrow, which symbolizes the transfer of the desired fractions in their respective proportions according to the mixing specification into the mixing device, particularly a screw extruder. The mixed fractions are then processed in a step 5 such that at the end, a mixture of r-TA and r-IA having an adjusted r-IA isomer content of between by weight and 25% by weight of the mixture is obtained.

FIG. 2 shows the processing step 5 in more detail. This begins with a base-catalyzed depolymerization 6 with the addition of NaOH and optionally water. At the end of this step, a stream of MEG, DEG and water is obtained, which stream is subjected to MEG purification 7, at the end of which MEG and DEG are obtained. The pasty material flow from the depolymerization 6 is subjected to a dissolving step 8 with the addition of water and sulfuric acid and residues RES are separated off in a filtering step 9. The desired product and, among other things, NaSO₄ are obtained in a crystallization step 10 with the addition of water and sulfuric acid, including subsequent filtration.

With great advantage, this method facilitates the obtaining of a mixture of r-TA and r-IA having a predetermined proportion of r-IA for further use as a high-quality starting material for the renewed manufacture of PET products. If this high-quality raw material is used, a step of adding IA in the production of the r-PET products is made superfluous, whereby r-PET products having equally good properties become less expensive. This is made possible by the analysis according to the invention of the starting materials and their mixing before processing. It is these additional steps of analysis and mixing that enable the production of a high quality product.

1. A method for the production of a mixture of recycled terephthalic acid (r-TA) and recycled iso-terephthalic acid (r-IA) from condensation polymer waste (CP waste), comprising steps of:
analyzing CP waste with regard to its IA content,
dividing the CP waste into two or more fractions having different IA content, mixing the fractions to achieve a desired IA content in the mixture, and processing the mixture to obtain a mixture of r-TA and r-IA having adjusted r-IA isomer content between 0.001% by weight and 25% by weight of the mixture.

2. The method according to claim 1, in which the CP waste is selected from the polyethylene naphthalates, polyethylene terephthalates, glycol-modified polyethylene terephthalates, polypropylene terephthalates, poly(ethylene terephthalate-co-isophthalate) copolymers, polybutylene terephthalate, polyethylene terephthalate copolymers, individually or in mixtures with 1,4-cyclohexanedicarboxylate structural units.

3. The methods according to claim 1, in which the division of the CP waste into a first fraction having an IA proportion of <0.1% by weight, a second fraction having an IA proportion of >0.1% by weight, preferably >1% by weight, optimally >1.5% by weight, and preferably a third fraction having an IA content of >3% by weight takes place.

4. The method according to claim 1, in which a step of compacting and/or comminuting one or more fractions takes place before the step of mixing.

5. The method according to claim 1, in which the mixing step takes place via gravimetric metering, particularly by means of gravimetric metering units in an extruder, wherein the mixture is preferably adjusted so that the isomer ratio (mol TA to mol IA) is between 100:0 and 75:25, preferably between 99:1 and 90:10 and optimally between 99:1 and 97:3.

6. The method according to claim 1, in which the processing step of processing comprises a base-catalyzed depolymerization in which a diol is obtained and a separation and purification of r-TA and r-IA.

7. The method according to claim 1, in which r-TA and r-IA products are obtained as salts rather than free acids.

8. The method according to claim 1, in which the products obtained are polymerized in a polymerization step to form r-PET products or to form r-PBT products or to form r-polypropylene terephthalate products.

9. A mixture of r-TA and r-IA having an r-IA content between by weight and 25% by weight of the mixture, obtainable by the method according to claim 1.

10. The mixture according to claim 9, wherein the mixture has an r-IA content between 0.01% by weight and 10% by weight of the mixture, particularly an r-IA content between 1.5% by weight and 3% by weight.

11. A use of the mixture according to claim 9 in a polymerization reaction to form r-PET, r-PBT, r-polypropylene terephthalate, further condensation polymers, for the production of alkyd resins or saturated and unsaturated polyester resins.
